(19) United States
(12) Patent Application Publication
(10) Pub. No.: US 2008/0143095 A1
(43) Pub. Date: Jun. 19, 2008

(54) Substrates Incorporating Security Devices

(76) Inventors: Roland Isherwood, Hampshire (GB); Duncan Hamilton Reid, Hampshire (GB)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/587,715

(22) PCT Filed: Apr. 29, 2005
(86) PCT No.: PCT/GB2005/001650

§ 371 Date: Aug. 10, 2007

(30) Foreign Application Priority Data
Apr. 30, 2004 (GB) 0409747.3

(51) Int. Cl. B42D 15/00

(52) U.S. Cl. 283/72

(57) ABSTRACT

The invention therefore comprises a security substrate (11) comprising a fibrous substrate and a security device (10) The security device (10) comprises an at least partially light transmissive polymeric carrier layer bearing a first security feature and the substrate being provided with a second security feature. The first and second security features are formed and located relative to each other such that, when one side of the security substrate (11) is viewed in transmitted light the first and second security features visually combine to form a first composite image, which is not seen in reflected light.

This invention is directed to improvements in substrates, such as paper, incorporating a security device, and to documents made therefrom.

It is generally known to provide security devices in or on security paper, as a security feature. Such devices can be patches, foils, threads, strips or ribbons of, for example, plastics film, metal foil, metallised plastic, metal wire. These security devices are included in the thickness of the security paper to render imitation of the documents produced from the paper more difficult. These devices help in the verification of security documents as they render the view of the documents in reflected light different from that in transmitted light. To increase the security provided by the inclusion of such a device, it is also known to endow the device itself with one or more verifiable properties over and above its presence or absence. Such additional properties include, for example, magnetic properties, electrical conductivities, the ability to absorb x-rays and fluorescence.

As a further security feature, it has been found to be particularly advantageous to provide windows in one or both surfaces of the security paper, which expose elongate security elements at spaced locations. Examples of methods of manufacturing paper incorporating security elements with or without windows are described below. It should be noted that references to “windowed thread paper” included windowed paper incorporating any elongate security thread. EP-A-0059056 describes a method of manufacture of windowed thread paper on a cylinder mould paper making machine. The technique involves embossing the cylinder mould cover and bringing an impermeable element into contact with the raised regions of an embossed mould cover, prior to the contact entry point; into a vat of aqueous stock. Where the impermeable elongate security element makes intimate contact with the raised regions of the embossing, no fibre deposition can occur. After the paper is fully formed and couched from the cylinder mould cover, the water is extracted from the wet fibre mat and the paper is passed through a drying process. In the surface of the finished paper the contact points are present as exposed regions that ultimately form windows, in which the security element is visible in reflected light.

WO-A-93/08327 describes a method of manufacturing windowed thread paper on a Fourdrinier paper-making machine. A rotating embedment means, with a modified profile for embossing, is used to drive an impermeable elongate security element into draining paper stock, on a Fourdrinier wire. The profile of the embedment means is such that raised portions are provided which remain in contact with the security element during the embedment process. Thus, paper fibres are prevented from collecting between the elongate security element and the embedment means, such that the elongate security element is subsequently exposed in window regions of the paper.

In Canadian patent specification CA-A-2122528, there is described an anti-falsification paper which incorporates a wide impermeable elongate security thread with a width between 2 mm and 4 mm. The paper is of multi-ply design, with at least two paper layers produced on separate paper machines. The elongate security thread is embedded in a first ply and has perforations along the edges which permit water drainage and hence paper fibre deposition along the edges of the thread. The elongate security thread is laid down over raised areas on the embossed cylinder mould cover before the raised areas enter the vat of paper stock so as to create windows of exposed elongate security thread in the contact regions. The width of the raised areas is narrower than the elongate security thread width to permit permeation through the perforations of the elongate security thread by paper fibres. However, the width of the elongate security thread is so great that the paper formed on the back of the paper has flaws in the form of arbitrary holes in the region of the elongate security thread. A second ply of ordinary paper is independently formed and the two are laminated together and further processed, the second ply thereby covering the flaws in the back of the first ply and providing at least one homogenous paper surface.

In another embodiment, a third ply is laminated over the front of the first ply to wholly embed the elongate security thread. In yet another embodiment, the width of the elongate security thread is selected to be so wide that no paper forms on the back of the first paper ply to provide a continuous exposed area. The elongate security thread may be laid on a continuous raised area on the mould cover before the raised areas enter the vat of paper stock to provide a continuous exposed area on the front of the first paper ply. A second ply of paper is then laminated to the first ply to form the finished security paper and give a homogenous paper layer on one side and a continuous exposed elongate security thread on the other.

WO-A-00/039391 describes a method of making single ply paper which can have a wide elongate security thread at least partially embedded therein. This is achieved by blinding one or more selected areas of a porous support surface, depositing a first layer of paper fibres onto the porous support surface around the blinded areas, bringing an impermeable elongate security thread to lie in contact with the blinded areas of the support surface such that at least the edges of the elongate security thread overlie the deposited layer, and depositing a further layer of paper fibres over the first layer and the impermeable strip to securely embed the edges of the elongate security thread within the paper. The blinded areas are impermeable, which substantially prevents the deposition of fibres thereon before the elongate security thread is laid thereover. Thus, substantially no paper fibres are deposited on one side of the elongate security thread in a central region between edges of the elongate security thread to thereby expose a continuous area of the elongate security thread at a first surface of the paper. Additionally a plurality of discrete translucent or transparent windows are formed in a second surface of the paper in which the elongate security thread is exposed.

The elongate security elements preferably carry visually recognisable security features. One class of visually recognisable security features are those that make use of metallised elongate security elements which are selectively partially demetallised to provide readily recognisable designs, patterns or other indicia.

An elongate security element of this type is described in U.S. Pat. No. 4,652,015 in which a resist and etch technique is used to selectively demetallise regions of a vacuum deposited aluminium layer on a polyester film, thereby leaving security indicia comprising metal characters on the plastic strip. The strip is wholly embedded in the paper and the metal characters are undetectable to the unaided eye and in reflective illumination whilst only becoming legible in transmitted light. However, this type of thread is unsuitable for windowed application because the characters are discrete and separated, the resulting look in windows being confusing and uneven.

A further improvement is described in patent specification EP-A-0319157, in which a partially metallised film is used which has metal-free portions of between 10% and 50% of the area of the device, the metal-free portions along the length of the device providing a repeating pattern, design or indicia. The metal layer, however, retains a continuous metal path along its length. Banknotes formed from elongate security elements as described therein provide excellent security and a public security feature in which the elongate security elements are eminently “readable” by the public when viewing the elements in transmitted light without the aid of a lens or other viewing accessory. In transmitted light the elongate security elements appear as black strips that very clearly stand out against their surroundings. In the embedded version, the elongate security elements are almost invisible when viewed with reflected light, although obviously the elongate security elements can be used in windowed paper also. In the windowed version, the elongate security element is seen in reflected light as silver blocks in the windows surrounding the metal free areas.

Such elongate security elements provide a suitable means for carrying information, indicia or other security features, which can be used to verify the authenticity of a document made from paper incorporating such elements. However, the elements are made separately from the paper and embedded during the paper/substrate making process usually without any correlation between the security element and the paper substrate. It is desirable to use the elongate security elements, or other security devices, to carry a plurality of different security features, which can be verified under a plurality of different viewing conditions, as this enhances the security of the resulting substrate in which they are embedded. It is also desirable to ensure that the position of the elongate security element or device is controlled so as to locate specific features in cooperation with the windows on the security paper.

It is therefore an object of the present invention to provide a security substrate with an elongate security device wholly or partially embedded therein, that is provided with one or more security features that are located in register or substantially in register with windows in the substrate such that the security device and the windows cooperate to define a composite security feature. The security features on the elongate security thread preferably cooperate with the windows when visually inspected in either transmitted or reflected light.

The invention therefore comprises A security substrate comprising a fibrous substrate and a security device, said security device comprising an at least partially light transmissive polymeric carrier layer bearing a first security feature and the substrate being provided with a second security feature, the first and second security features being formed and located relative to each other such that, when one side of the security substrate is viewed in transmitted light the first and second security features visually combine to form a first composite image, which is not seen in reflected light.

Preferably the first and second security features are formed and located relative to each other such that, when said one side of the security substrate is viewed in reflected light the first and second security features visually combine to form a second composite image which is different from the first composite image.

The invention is advantageous in that the co-operative effect of the security features on the security device and security substrate improves security by providing a clear visual link between the two components. Such a link would be extremely hard for a counterfeiter to replicate.

It is also an object of the present invention that all documents within a series or subset of a series of documents are identical or substantially identical with respect to the location of the security features on the elongate security thread and the position of the windows in the substrate.

The present invention will now be described, by way of example only, with reference to the accompanying drawings in which:

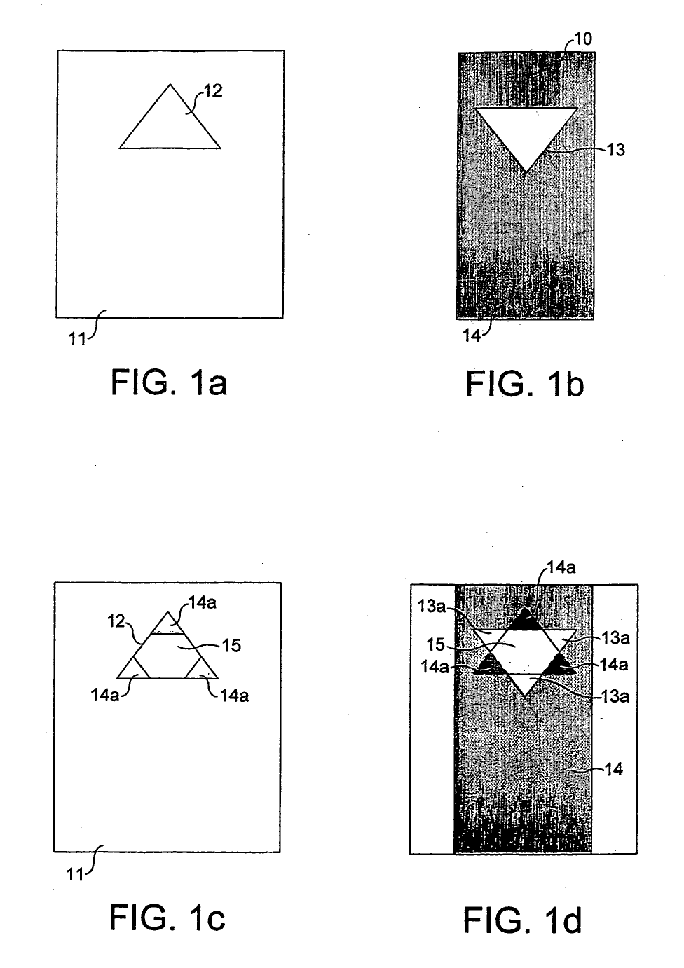

FIGS. 1a to 1d illustrate a first example of the invention, in which FIG. 1a is a plan view of the substrate, FIG. 1b is a plan view of the security device and FIGS. 1c and 1d are plan views of the combined substrate and security device;

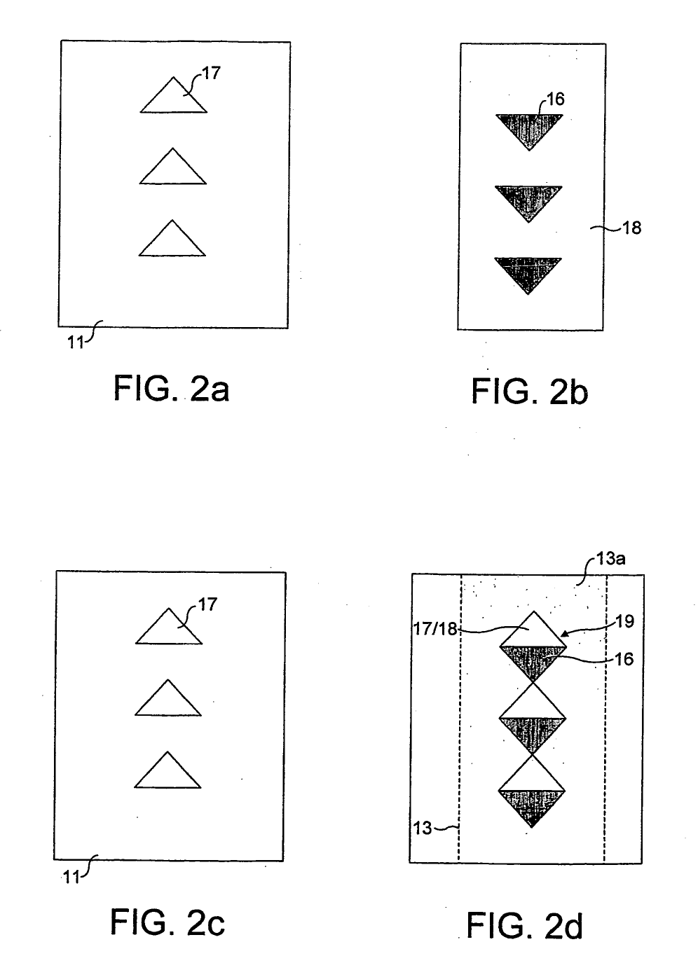

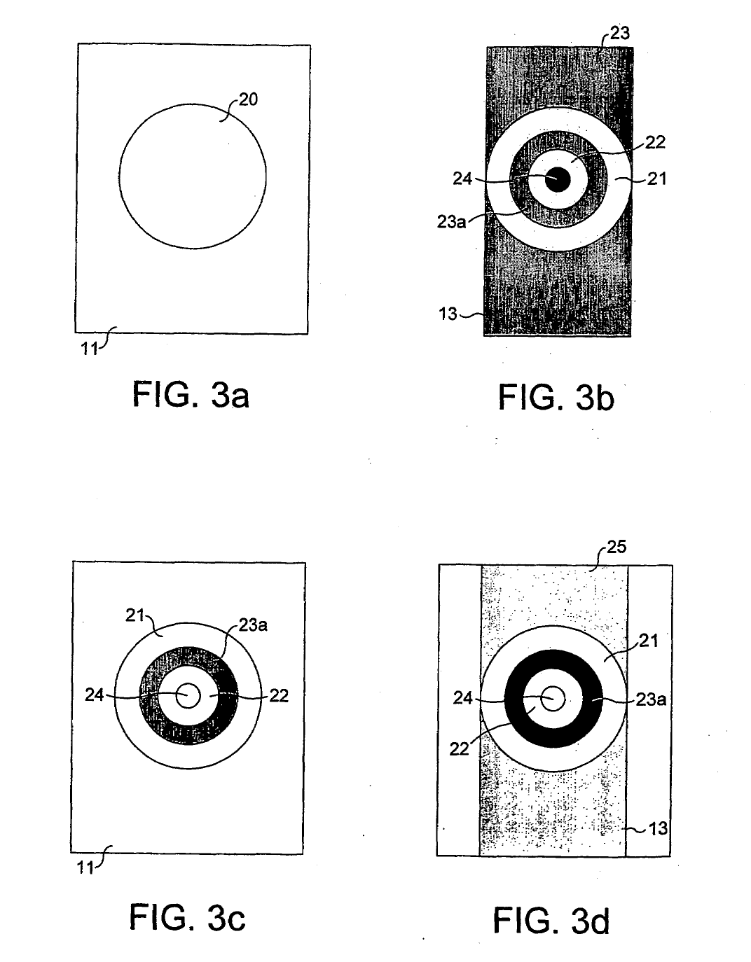

FIG. 2a to 2d and 3a to 3d illustrate second and third examples of the invention; and

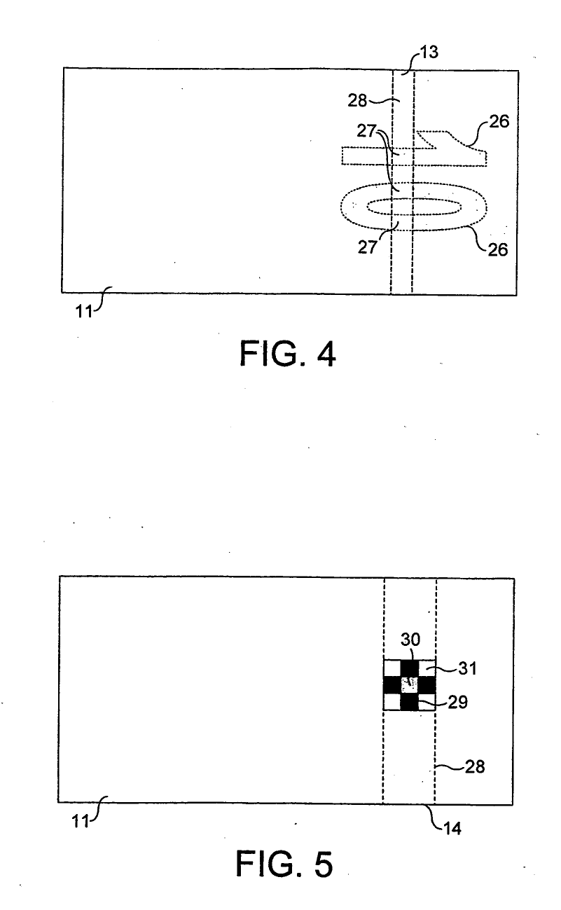

FIGS. 4 to 7 are plan views of further alternative security substrates according to the present invention.

The invention comprises a security device in the form of an elongate security element 10, which in one embodiment of the invention, is partially embedded into a fibrous substrate 11, such as security paper. The security element 10 comprises a carrier of a suitable plastic material which is flexible and water impermeable and which is at least partially light transmissive, but preferably substantially transparent. A suitable material would be PET. The security element 10 comprises a first security feature and the substrate 11 has a second security feature, preferably in the form of one or more apertures, windows, watermarks or the like. Each of the security features must be visually apparent in reflected and/or transmitted light.

The security substrates of the present invention have a wide variety of applications, particularly as security documents, such as banknotes, passports, bonds, certificates, vouchers or other documents of value.

An essential aspect of the present invention is the ability to register the security features of the elongate security element 10 and the substrate 11 such that they combine when viewed in transmitted light to provide a composite image. Techniques describing how registration of the security element and the substrate 11 might be achieved are described in WO-A-03/023140 and GB 0228424.8.

WO-A-03/023140 is characterised in that security features are provided onto the elongate security thread directly before the step for incorporating the elongate security thread into the substrate. The distinctive markings can thereby be provided in register with at least one portion of the substrate.

GB-A-0228424.8 describes an alternate method for providing elongate security threads in register to the substrate and is characterised in that the elongate security element is provided with a reference mark or other feature that can be detected and used to monitor its location. Similarly the substrate being formed is also provided with some means to monitor its location. A feedback mechanism then uses the information obtained on the location of the substrate and elongate security thread to ensure that the two are maintained in register.

The above techniques can be used in conjunction with any of the previously described methods for inserting elongate security threads into paper. Herein the examples are all described with reference to substrates produced via the method described within WO-A-00/039391, however it should be noted that this is for illustrative purposes only and alternate methods may be used.

FIGS. 1a to 1d illustrate a first embodiment of the present invention utilising demetallised indicia as the first security feature and an aperture through the substrate (i.e. a region of zero density) as the second security feature. FIG. 1b shows a partially metallised security element 10 having a demetallised (transparent) or partially demetallised (semi-transparent) region 13 within a metal region 14. The element 10 is partially embedded in the substrate 11 (FIG. 1a) such that the regions 13 and 14 interact with the aperture 12 in the substrate 11 formed by the controlled deposition of paper fibres. For clarity the appearance of the security substrate 11 illustrated in both reflected and transmitted light is shown in FIGS. 1c and 1d respectively.

The substrate is manufactured in accordance with the teaching within WO-A-00/039391, and in this instance, the cylinder mould cover is blinded so as to produce an aperture 12 that is triangular in shape. Similarly the elongate security element 10 is a partially demetallised transparent polyester or polypropylene carrier film where the demetallised region 13 also defines a triangle, the triangle on the elongate security element 10 being inverted compared to that of the aperture 12 in the substrate 11. The elongate security element 10 is partially embedded in the substrate 11 such that the triangles overlap each other. On a first surface of the substrate 11, the security element 10 is only exposed in the region of the triangular aperture 12, but on an opposing second surface a continuous strip of the element 10 may be exposed.

When the resultant security substrate is viewed in reflected light (FIG. 1c) from the side of the first surface of the substrate 11, the shape of the window 12 can be seen as a large triangle. Within this large triangle can be seen three smaller triangles of metal 14a at its apexes, which are the parts of the metal region 14 which overlap with the window 12, and a central wholly transparent region 15 that is hexagonal in shape. The central region 15 occurs where the aperture 12 and the demetallised region 13 overlap. When viewed in transmitted light (FIG. 1d), again viewing from the side of the first surface, the composite image is of a large triangle that is inverted compared to the one seen in transmitted light. This second triangle has three darker smaller triangles 13a at its apexes and the central wholly transparent hexagonal area 15. In this instance regions of fibre deposition define the three smaller triangular areas 13a. In FIG. 1d, although there are illustrated the same three smaller triangles 14a as shown in FIG. 1c representing metal areas not covered by paper fibres, in practice these areas 14a will not be distinguishable from the rest of the metallised region 14 covered by the substrate 11 when the security substrate is viewed in transmission.

The overall effect is visually striking and easily recognisable to the user and additional is extremely hard to counterfeit due to the complexity and difficulty of placing the demetallised elongate security element 10 in register with the window region 12 of the substrate 11.

FIGS. 2a to 2d show a second embodiment of the present invention. In this embodiment the substrate 11 is again produced in accordance with WO-A-00/039391 and the blinded regions on the mould cover are provided so as to create a series of triangular apertures 17 (FIG. 2a). The elongate security element 13 (FIG. 2b) comprises a metallised carrier of transparent polyester or polypropylene that has been demetallised over the majority of its surface to provide a series of small metallic triangular regions 16 on a clear non-metallised area 18. The elongate security element 13 is partially embedded in the substrate 11 such that on a first surface of the substrate 11 it is only exposed in the triangular apertures 17. On the second surface a continuous strip of the element 13 may be exposed. The metallic triangular regions 16 are regularly spaced and inverted with respect to those that define the apertures 17 in the substrate 11. The elongate security element 13 is partially embedded in the substrate 11 such that the triangular apertures 17 and the metallic regions 16 abut each other in register with respect to each other.

When the security substrate is viewed from the side of the first surface of the substrate 11 in reflected light (FIG. 2c) a series of clear transparent apertures 17 can be seen that are regularly spaced and triangular in shape. When the security substrate is viewed in transmitted light, again viewing from the side of the first surface, the composite image is seen as a series of diamonds 18. Each diamond 19 comprises two halves, the upper half being a clear transparent region, where an aperture 17 overlaps the non-metallic area 18, and the lower half being a dark opaque region defined by the metallic regions 16 on the security element 13. The two halves of each diamond 19 are in register and abut each other.

As in the first embodiment the contrast between the views in transmitted and reflected light provides a strong visual security feature. Additionally the registration between the metallised regions 16 and the apertures 17 is extremely hard for a counterfeiter to replicate.

In a further embodiment of the invention, a metallised elongate security element with demetallised triangles is partially embedded in a substrate 11 having similar apertures 17 as detailed above. The elongate security element 13 must be positioned such that the demetallised triangles abut and are in register with the triangular apertures 17 in the substrate 11.

FIG. 3 illustrates a third embodiment of the invention comprising an elongate security element 13 provided with metal, non-metal and printed regions. In this embodiment the substrate 11 is again produced in accordance with WO-A-00/039391. The cylinder mould cover is provided with a blinded area in the shape of a large circle which forms a circular aperture 20 in the substrate 11. The elongate security element 13 is partially embedded in the substrate 11 such that on the first surface of the substrate 11 it is only exposed in the circular aperture 20. On second surface a continuous strip of the security element may be exposed. The elongate security element 13 comprises a metallic transparent polyester or polypropylene carrier film that has been selectively demetallised to provide a large demetallised annular region 21 within which is a smaller annular metallised annular region 22.

In addition to the metal and non-metal areas 23, 21/22 the elongate security element 13 is also provided with a printed circular area 24.

The overall effect is that of a number of concentric circles, having different appearances. The elongate security thread 13 is inserted into the substrate 11 such that the concentric circles are located within the circular aperture 20 of the substrate 11.

When the resultant security substrate is viewed in reflected light (FIG. 3a), from the side of a first surface of the substrate, a series of concentric circles are visible. The outer circle is defined by paper fibres, followed by the transparent annular region 21, followed by an opaque metal area 23a, followed by the second transparent annular region 22 and finally the central printed area 24. In one embodiment the central print area 24 is printed using iridescent ink that is partially transparent but shows a colour shifting effect under different viewing angles. The iridescent may be applied after the elongate element 17 has been inserted into the substrate 11 and during the printing of a security document made from the security substrate.

When viewed in transmission (FIG. 3d) from the same side of the substrate 11 the composite image which becomes visible comprises a dark background area 25 which is defined by the metallised areas 23 of the elongate security thread which are covered by the substrate 11. Within this background area 25 there is the transparent region 21 followed by a dark annular area formed from the metal region 23a, followed another transparent region 22 and finally a central coloured transparent circle formed by the printed area 24. The colouring of this area resulting from the presence of the iridescent pigment.

The printed area may be applied over a metal or non-metal area and may be applied by any of the known printing techniques such as for example screen, flexography, lithography, intaglio, gravure, dye diffusion, laser, ink jet and toner transfer. The printed area 24 may be provided either before or after insertion of the elongate security element 13 in to the substrate 11. Indeed in some instances the printed area 24 could be a combination of print applied both before and after insertion of the elongate security element 13 in to the substrate 11.

In a preferred example the ink or dye used for the printed area 24 has some optically variable properties. The ink may be, for example, metallic and of a different colour to the metallised areas, optically variable ink (OVI) as supplied by Sicpa, iridescent, or liquid crystal. The ink may not show optically variable effects but may instead provide some other benefit such as machine readability and comprises any one or more of at least luminescent materials, magnetic materials, x-ray absorbing materials, or conductive materials. Such inks may be visible or invisible. It should also be appreciated that normal coloured inks, which may be opaque or translucent, could also be used. As a further alternative, an optically variable feature can be used in which are in other forms, such as films, for example liquid crystal films.

The resultant security substrate is easily recognisable and also highly secure in that it is hard to counterfeit. The above example requires registration between the elongate security element 13, the substrate 11 and the printing process to apply the printed region 24. This requires registration between two distinct processes within the production of the security substrate, namely the manufacture of the security substrate and the printing of the security document formed from the substrate.

A further embodiment of the invention is illustrated in FIG. 4 in which the first security feature provided on the security element 13 comprises indicia, which may be demetallised or printed, and the second security feature provided on the substrate is a watermark.

An elongate security element 14 is inserted into the substrate 11 which is provided with a watermark 26. The watermark 26 in this instance defines the number “10”. The security element 13 then passes through three regions 27 of the watermark 26. The security element 13 is preferably fully embedded and is only metallised in the areas 27 where it will intersect with the watermark 26. Regions 28 of the security element 14 surrounding regions 27 are clear. In transmitted light the metal regions 27 comprise part of the watermark numeral “10”.

The metallised security element 13 may have areas of differing metal density along its length. The way in which the metal density varies is dependent upon where the watermark 26 is defined by increased or decreased fibre deposition. Where the watermark 26 has a greater fibre density than the majority of the remainder of the sheet, i.e. it appears dark against a light background, the regions 27 of the security element 13 that intersect with the watermark 26 have a higher metal density than on the remainder of the security element 13. Alternatively, where the watermark 26 has a lower fibre density than the majority of the remainder of the substrate 11, i.e. it appears lighter against a dark background, the regions 27 of the security element 13 that intersect with the watermark 26 have a lower metal density than on the remainder of the security element 13.

Another variant which can be used in this embodiment is where the security element 13 is partially embedded and is exposed at the points where it intersects with the watermark 26. However is not sufficient that the security element 13 merely windows at the intersections, but it must additionally have some feature that cooperates with the watermark 26 at the point of intersection. As for the above examples this cooperative feature may be defined by optical density, metallisation or possible print features.

The appearance of the first and second security features may both be abstract in appearance when viewed as separate elements and only form a recognisable design when viewed together. This approach is not dissimilar to that used when producing printed see through features, examples of which can be found in EP-B-388090.

Where the second security feature is a watermark, it may be provided as either a positive or negative watermark, i.e. having areas of either higher or lower fibre deposition relative to the fibre density in the rest of the substrate or both.

In yet a further embodiment, the composite image is made more complex by using a multitonal watermark as the second security feature rather than a simple positive or negative watermark as in the previous embodiment.

FIG. 5 shows a relatively simple example of a multitonal watermark used in combination with a first security feature comprising demetallised or printed indicia to form the composite image design. In this example a checkerboard design is defined by a combination of higher and lower paper fibre density areas and a printed design on the security element 13.

The security element 13 has clear regions 28 surrounding a printed design 29. The design 29 is printed with coloured inks that are partially transparent and are of a single colour or multiple colours. In the substrate is provided a first watermark 30, being an area of lower fibre deposit, and second watermark areas 31, comprising areas of higher fibre deposit. As before, the terms higher and lower fibre deposit are relative to the Level of fibre deposition for the majority of the substrate. When viewed in transmission there can be seen a multitonal checkerboard design with additional coloured elements.

The printed design 29 may be replaced by a metallic design. Metal deposits forming the design 29 may be wholly opaque or partially transparent depending upon the metal density. As a further alternative the security element 13 may be metallised over its whole surface and then metal regions removed to leave non-metal areas corresponding to the design 29. The non-metal areas may be left wholly transparent or be printed with transparent or translucent inks such that when viewed in transmission a coloured appearance or effect can be seen.

FIG. 5 shows a relatively simply design, which is suitable for forming composite images that have particular significance to the finished document formed from the security substrate. For instance, for a passport or national currency the composite design may be a national flag or symbol.

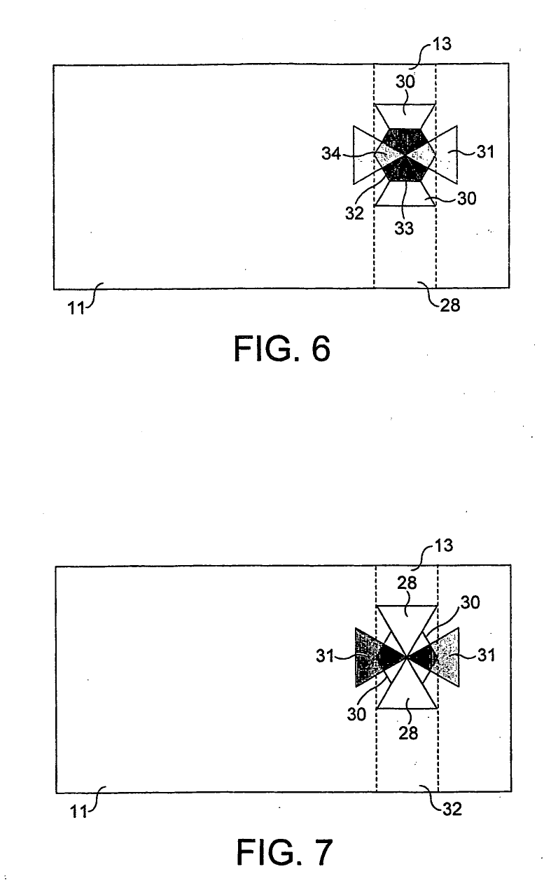

FIG. 6 shows an embodiment of the invention in which the first security feature on the security element 13 works in combination with second and third security features in the substrate, namely a watermark and an aperture. The aperture comprises an area of substrate 11 with zero fibre density. This region of zero fibre density can be provided during the paper making process or after as a subsequent conversion process, e.g. laser ablation or die cutting.

In this embodiment the substrate 11 is provided with apertures 30 and watermark areas 31, which comprise traditional watermarks, i.e. having regions of paper of a fibre density either higher or lower than the remainder of the substrate. The apertures 30, which may be zero density areas of the watermark, and watermark areas 31 together define a stylised cross design which, in itself, is a composite design. In register with these areas 30, 31 is the first security feature on the security element 13, which comprises a metallised design. The metallised design comprises areas 32, 33, 34 of metal surrounded by a non-metal area 28. The areas 32, 33 and 34 have differing appearances in transmission due to the different levels of fibre deposition on the surface of the security element 13.

In a more complex example, each of the regions 28, 32, 33, 34 has a different appearance due to any combinations of metallisation, demetallisation, print, metal effect inks, colourshift inks, diffractive effects and the like.

FIG. 7 shows another embodiment of how a metallised design on the security element can be used in combination with a paper sheet having a watermark 31 which has areas of reduced and/or differing fibre density, apertures or windows 30, which could be formed as a part of the watermark wherein the areas 30 have zero density. The security element 13 is metallised and has demetallised regions 28 forming the design leaving a metallised area 32 surrounding the design. The combination of the aperture and watermark areas 30, 31 together with the metallised and demetallised regions 32, 28 provides a complex but readily recognisable composite image.

In an alternate embodiment, the metallised 28 and demetallised regions 32 may be reversed. Other combinations are possible, as described above, making use of colourshift layer, diffractive effects print features etc.

In all the examples illustrated the various apertures, demetallised, metallised and printed areas as defining simple geometric shapes. Alternatives to simple geometric shapes can be used, such as alphanumeric characters, patterns, screens and other indicia.

The preceding examples also only refer to the use of watermarks and apertures in the substrate 11. Alternatively, the substrate 11 may be provided with other security features, such as electrotypes, windows and the like.

Electrotypes have been known in security paper making for over 100 years and is in effect a single tone watermark. An electrotype is a thin piece of metal or other impermeable material in the form of an image or other indicia applied to the mould cover. The electrotype is attached by sewing, welding or adhesive and results in a significant decrease in drainage and thus fibre deposition and forms a light mark in the finished paper. This type of process is well known in paper making and has been described in the prior art, see U.S. Pat. No. 1,901,049 and U.S. Pat. No. 2,009,185.

The elongate security element may also be substituted by any form of security device such as security threads, foils, stripes, patches or foil transfers. Foil transfers are similar to foil stripes, but where a carrier material is left in place following transfer rather than being stripped away. Foil transfers are particularly suitable for applying foils over apertures or holes formed in a substrate. The security devices may be partially embedded in the substrate 11 as described in the above examples, wholly embedded within the substrate 11 or applied to one surface or the substrate 11.

The security devices may also have features other than the metallised, demetallised or printed areas described above, some examples of which are described below:

bimetallic features, comprising the use of vacuum metallised layers of different metals, such as aluminium or copper. A combination of several metal types can be used.

diffractive features, in which the security devices are provided with a diffractive layer, of the type widely used in the field of security devices. The diffractive layer may be formed by traditional dual beam interferometry or via direct write techniques such as dot matrix or ebeam. Where a direct write approach is undertaken, preferred types of devices include Kinegrams, Exelgrams and Pixelgrams. In order to visual a diffractive effect it is also necessary to provide a reflection enhancing layer. Suitable reflection enhancing layers include reflective metal layers, e.g. aluminium, or high refractive index layers, e.g. ZnS. High refractive index layers have the additional benefit of being transparent and can thus be used in conjunction with print layers under the diffractive effect. A similar effect can be achieved by selectively demetallising a metal reflection enhancing layer to form a fine screen of metal dots.

optical thin film devices, such as are discussed within “optical Document Security”, Second Edition, Chapter 13, edited by Ruduolf van Renesse. For this particular application both all dielectric and metal dielectric structures are of interest. Both all dielectric and metal dielectric structures may be deposited directly onto the carrier film or alternatively formed on a separate carrier and transferred. The transfer may be as a lamination of heat transfer step or alternative the thin film optic layers may be flaked off a carrier to give pigment flakes. The pigment flakes can then be suspended in a suitable vehicle applied as an ink. OVI inks supplied by SICPA are examples of metal dielectric pigments suspend in an ink vehicle.

liquid crystal materials, which can be used to create novel and interesting optical effects. Some background on the use of liquid crystal materials in Security document can be found in “Optical Document Security”, Second Edition, Chapter 14, edited by Rudolf van Renesse. When using liquid crystal materials it is preferable to use them in conjunction with a dark background to enhance the visibility of the colour shifting effects. The dark background may be present as a printed ink layer. In one preferred embodiment described in WO-A-03061980 the liquid crystal is applied over a metal layer which has been selectively demetallised using a resist and etch approach, the resist in this instance being provided with a dark or black pigment or dye. As a consequence of the resist and etch process the dark resist will remain in perfect register with the metal areas.

microprism and microlens arrays, which are examples of non-diffractive optical effect structures. Specific examples of such structures can be found in pending patent applications GB0504959.8 and GB0409783.8.

thermochroic and photochroic features, which comprise materials that change appearance under an external influence. Examples of suitable constructions of security elements making use of thermochromic materials are given in EP-A-608078 and EP-A-1161352.

luminescent materials, which can be provided either as a print layer or within the polymer carrier of the security device itself. The luminescent materials may show fluorescence or phosphorescence. Alternatively a mixture of different fluorescent and/or phosphorescent materials may be used. In a preferred example luminescent materials may be used in conjunction with demetallised layers as described with EP-A-319157. A particularly beneficial example of combining fluorescence with demetallised designs is marketed as FACET® by De La Rue International Limited.

magnetic and other machine readable characteristics, which are increasingly sought after features for security devices. Such features can be detected and used to authenticate and sort documents using high speed machinery. Examples of machine-readable features include conductive luminescent and magnetic. A magnetic layer can be applied under or on top of a print, or metallic layer in order to disguise its dark appearance. Alternatively the magnetic material itself can be used as a print layer, which is particularly preferable for soft magnetic pigments that are generally lighter in colour than hard magnetic pigments. As a further alternative so called transparent magnetic materials can be used on threads, such as are described in WO-A-03091953 and WO-A-03091952.

varying width threads, which have, for example, a variation in width along their length can be inserted into paper to create novel effects.

It will be appreciated by those skilled in the art that there are numerous constructions possible for security devices suitable for use in the current invention. The above list is not exhaustive but merely illustrative of some of the potential features.

1. A security substrate comprising a fibrous substrate and a security device, said security device comprising an at least partially light transmissive polymeric carrier layer bearing a first security feature and the substrate being provided with a second security feature, the first and second security features being formed and located relative to each other such that, when one side of the security substrate is viewed in transmitted light the first and second security features visually combine to form a first composite image, which is not seen in reflected light.

2. A security substrate as claimed in claim 1, in which the first and second security features are formed and located relative to each other such that, when said one side of the security substrate is viewed in reflected light the first and second security features visually combine to form a second composite image which is different from the first composite image.

3. A security substrate as claimed in claim 1, in which the security device is at least partially embedded within the fibrous substrate.

4. A security substrate as claimed in claim 2, in which the security device is wholly embedded within the fibrous substrate.

5. A security substrate as claimed in claim 1, in which the security device is applied to a surface of the fibrous substrate on a second side of the substrate.

6. A security substrate as claimed in claim 1, in which the first security feature comprises a plurality of opaque and at least partially light transmissive regions.

7. A security substrate as claimed in claim 1, wherein the first security feature comprises a plurality of metal and non-metal regions.

8. A security substrate as claimed in claim 1, in which the first security feature comprises printed indicia.

9. A security substrate as claimed in claim 1, in which the first security feature comprises an optically variable feature.

10. A security substrate as claimed in claim 1, in which the first security feature comprises a thermochromic, photochromic or luminscent feature.

11. A security substrate as claimed in claim 1, in which the first security feature comprises a machine readable feature.

12. A security substrate as claimed in claim 11, in which the first security feature comprises a magnetic feature.

13. A security substrate as claimed in claim 1, in which the second security feature comprises a feature formed by one or more regions of reduced or zero density in the substrate.

14. A security substrate as claimed in claim 13, in which the second security feature comprises a watermark feature.

15. A security substrate as claimed in claim 13, in which the second security feature comprises at least one aperture in the fibrous substrate.

16. A security substrate as claimed in claim 13, in which the second security feature is an electrotype.

17. A security substrate as claimed in claim 10, in which the second security feature comprises at least one window in at least one surface of the fibrous substrate.

18. A security substrate as claimed in claim 1, in which the security device is provided with a plurality of first security features.

19. A security substrate as claimed in claim 1, in which the substrate is provided with a plurality of second security features which visually combine with one or more first security features of the security device to form a plurality of composite images.

20. A security document formed from the security substrate as claimed in claim 1.

21. A security document as claimed in claim 20, comprising a banknote, passport, bond, certificate, voucher or other document of value.

22. (canceled)
